(19) United States
(12) Patent Application Publication
(10) Pub. No.: US 2026/0058412 A1
(43) Pub. Date: Feb. 26, 2026

(54) CABLE CONNECTOR HAVING FIRST METAL BAR TO POSITION FIRST CABLE MODULE

(71) Applicant: Shanxi Luxshare Precision Industry, Ltd., Changzhi City (CN)

(72) Inventors: Fang WANG, Changzhi City (CN); Chen HUANGFU, Changzhi City (CN)

(73) Assignee: Shanxi Luxshare Precision Industry, Ltd., Changzhi City (CN)

(21) Appl. No.: 19/095,663

(22) Filed: Mar. 31, 2025

(30) Foreign Application Priority Data
Aug. 22, 2024 (CN) 202411154378.7

(51) Int. Cl. H01R 13/6581

(52) U.S. Cl. CPC H01R 13/6581

(57) ABSTRACT

A cable connector includes a base portion, a metal shielding piece, a number of first conductive terminals and a first cable module. The base portion includes a first surface, a first rib protruding beyond the first surface along a first direction and a first positioning block further protruding beyond the first rib along the first direction. The first positioning block is provided with a first positioning surface. The first cable module includes a first metal bar and a number of first cables. The first metal bar is provided with a first abutting surface. The first metal bar is supported on the first surface of the base portion. The first abutting surface of the first metal bar abuts against the first positioning surface of the first positioning block along a second direction to limit the first cable module in the second direction. The first metal bar is in contact with the metal shielding piece.

### CROSS-REFERENCE TO RELATED APPLICATION

This patent application claims priority of a Chinese Patent Application No. 202411154378.7, filed on Aug. 22, 2024 and titled “CABLE CONNECTOR”, the entire content of which is incorporated herein by reference.

### TECHNICAL FIELD

The present disclosure relates to a cable connector, which belongs to the technical field of connectors.

### BACKGROUND

Cable connectors in the related art usually include an insulating body, a plurality of conductive terminals mounted to the insulating body, and a cable module in contact with the conductive terminals. The insulating body is usually provided with a plurality of terminal tail portion mounting grooves. Each conductive terminal includes a tail portion disposed in a corresponding terminal tail portion mounting groove. The cable module usually includes a plurality of cables. Each cable includes a core wire fixed to the tail portion of the conductive terminal.

However, when the cable module is mounted to the insulating body and corresponds to the conductive terminals, due to the lack of positioning of the cable module, the cable module is prone to misalignment, which reduces the yield of the manufacturing process.

Therefore, it is desirable to improve the cable connector in the related art.

### SUMMARY

An object of the present disclosure is to provide an improved cable connector.

The present disclosure adopts the following technical solution: a cable connector, including: a base portion, the base portion including a first surface, a plurality of first ribs extending beyond the first surface along a first direction, and a first positioning block further extending beyond at least one of the plurality of first ribs along the first direction; a first terminal tail portion mounting groove being formed between two adjacent first ribs; the first positioning block being provided with a first positioning surface located at an end of the first terminal tail portion mounting groove along a second direction perpendicular to the first direction; a metal shielding piece, the metal shielding piece being coupled to the base portion; a plurality of first conductive terminals, each first conductive terminal including a first tail portion which is at least partially received in a corresponding first terminal tail portion mounting groove; and a first cable module, the first cable module including a first metal bar and a plurality of first cables; the first metal bar including a first abutting surface; each first cable including a first core wire protruding beyond the first abutting surface; wherein the first cable module is mounted to the base portion; the first metal bar is supported on the first surface of the base portion; the first abutting surface of the first metal bar abuts against the first positioning surface of the first positioning block along the second direction, so as to limit the first cable module in the second direction; the first core wire of the first cable is configured to be electrically connected to a corresponding first tail portion of the first conductive terminal; the first metal bar is in contact with the metal shielding piece.

The present disclosure also adopts the following technical solution: a cable connector, including: an insulating body defining a mating cavity; a base portion mounted to the insulating body, the base portion including a first surface, a plurality of first ribs integrally extending beyond the first surface along a first direction, and a first positioning block further integrally extending beyond at least one of the plurality of first ribs along the first direction; a first terminal tail portion mounting groove being formed between two adjacent first ribs; the first positioning block being provided with a first positioning surface; a metal shielding piece mounted to the base portion, the metal shielding piece including at least one abutting elastic arm extending into the mating cavity; a plurality of first conductive terminals, each first conductive terminal including a first tail portion which is at least partially received in a corresponding first terminal tail portion mounting groove; and a first cable module, the first cable module including a first metal bar and a plurality of first cables fixed together with the first metal bar; the first metal bar including a first abutting surface; each first cable including a first core wire protruding beyond the first abutting surface; wherein the first cable module is mounted to the base portion; the first metal bar is supported on the base portion; the first abutting surface of the first metal bar abuts against the first positioning surface of the first positioning block along a second direction, so as to limit the first cable module in the second direction; the second direction is perpendicular to the first direction; the first core wire of the first cable is configured to be electrically connected to a corresponding first tail portion of the first conductive terminal; the first metal bar is in contact with the metal shielding piece.

### BRIEF DESCRIPTION OF DRAWINGS

FIG. 1 is a schematic perspective view of a cable connector in accordance with an embodiment of the present disclosure;

FIG. 2 is a perspective view of FIG. 1 from another angle;

FIG. 3 is a top view of FIG. 1;

FIG. 4 is a bottom view of FIG. 1;

FIG. 5 is a partially exploded perspective view of the cable connector shown in FIG. 1, in which a first metal outer shell and a second metal outer shell are separated;

FIG. 6 is a partially exploded perspective view of FIG. 5 from another angle;

FIG. 7 is a further perspective exploded view after removing the first metal outer shell and the second metal outer shell shown in FIG. 5, in which an insulating body is separated;

FIG. 8 is a partial enlarged view of circled portion B in FIG. 7;

FIG. 9 is an exploded perspective view of FIG. 7 from another angle;

FIG. 10 is yet an exploded perspective view of FIG. 7 from another angle;

FIG. 11 is a further perspective exploded view after removing the insulating body in FIG. 7, in which a first cable module and a second cable module are separated;

FIG. 12 is an exploded perspective view of FIG. 11 from another angle;

FIG. 13 is yet an exploded perspective view of FIG. 11 from another angle;

FIG. 14 is a partial enlarged view of circled portion C in FIG. 13;

FIG. 15 is a partial enlarged view of circled portion D in FIG. 13;

FIG. 16 is an exploded perspective view of a plurality of first conductive terminals, a plurality of second conductive terminals and a shielding piece assembly in FIG. 11;

FIG. 17 is an exploded perspective view of FIG. 16 from another angle;

FIG. 18 is yet an exploded perspective view of FIG. 16 from another angle;

FIG. 19 is a schematic cross-sectional view taken along line E-E in FIG. 3;

FIG. 20 is a partial enlarged view of frame part F in FIG. 19;

FIG. 21 is a schematic cross-sectional view taken along line G-G in FIG. 1; and

FIG. 22 is a schematic cross-sectional view taken along line H-H in FIG. 1.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of”mentioned in the present disclosure includes two or more.

Hereinafter, some embodiments of the present disclosure will be described in detail with reference to the accompanying drawings. In the case of no conflict, the following embodiments and features in the embodiments can be combined with each other.

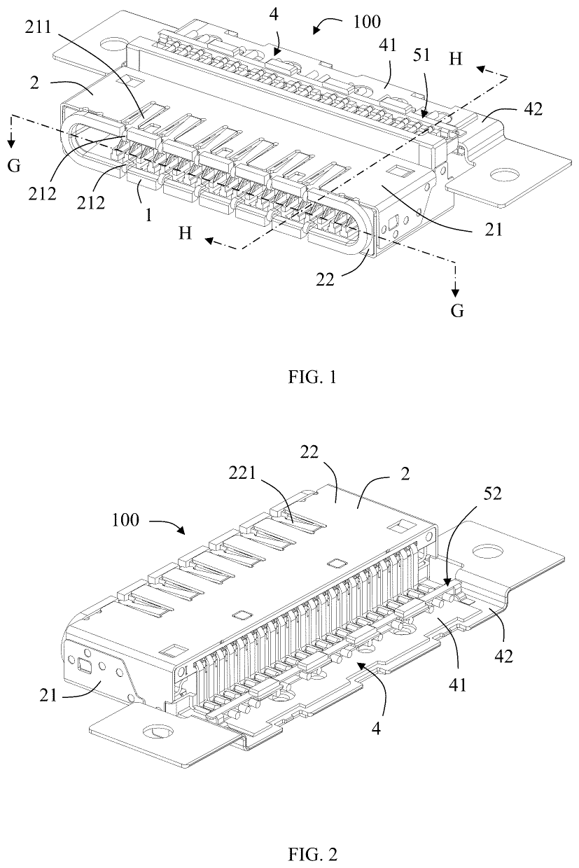

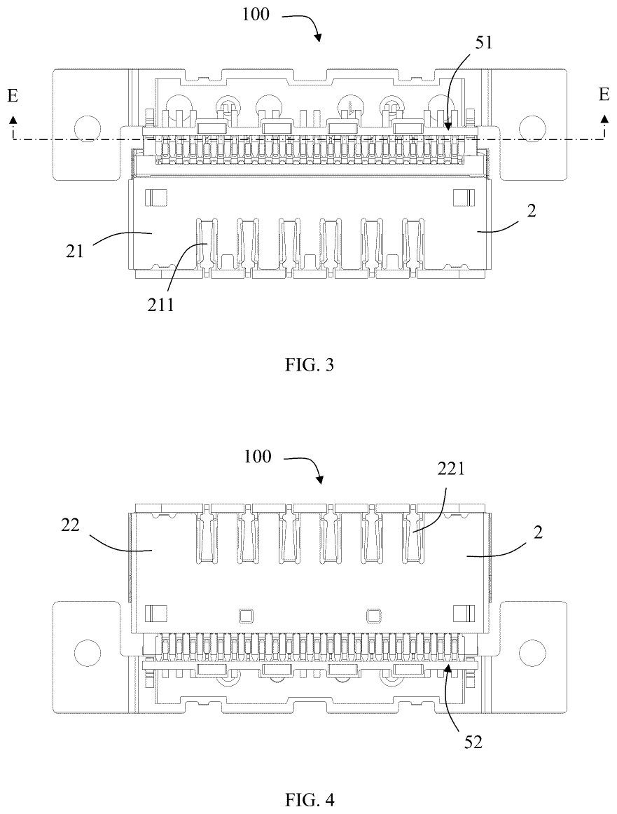

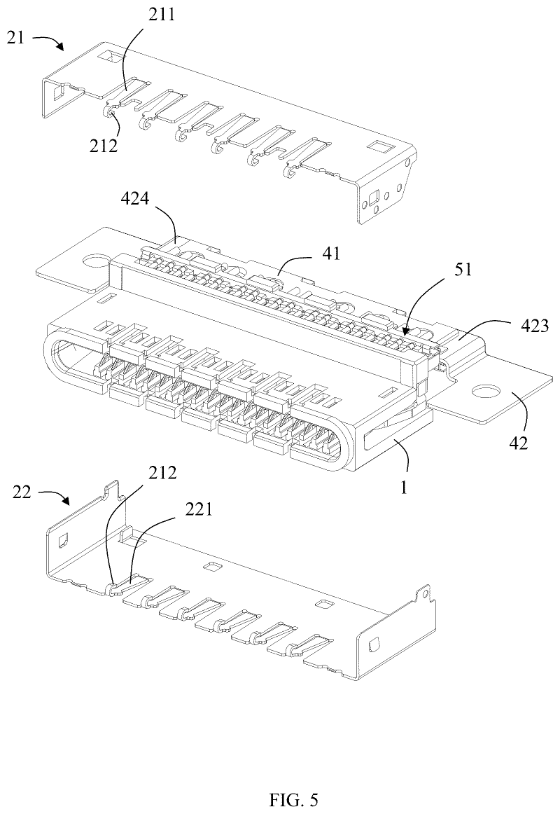

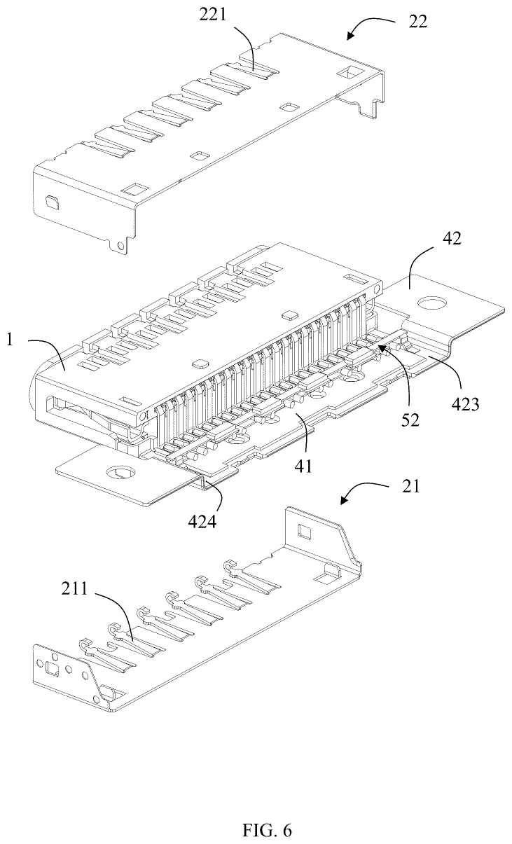

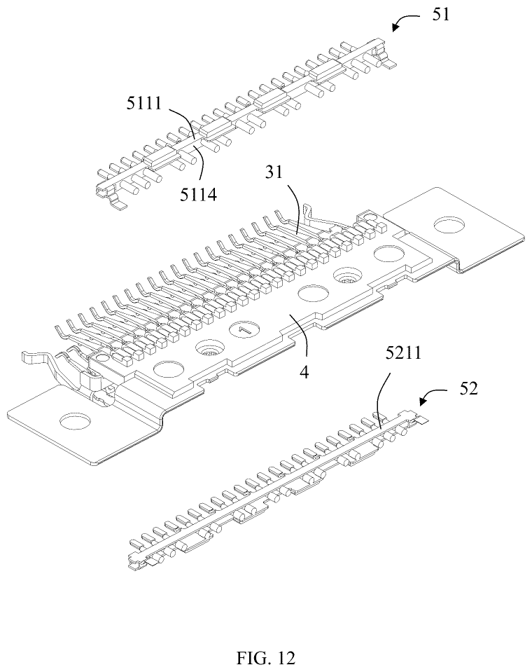

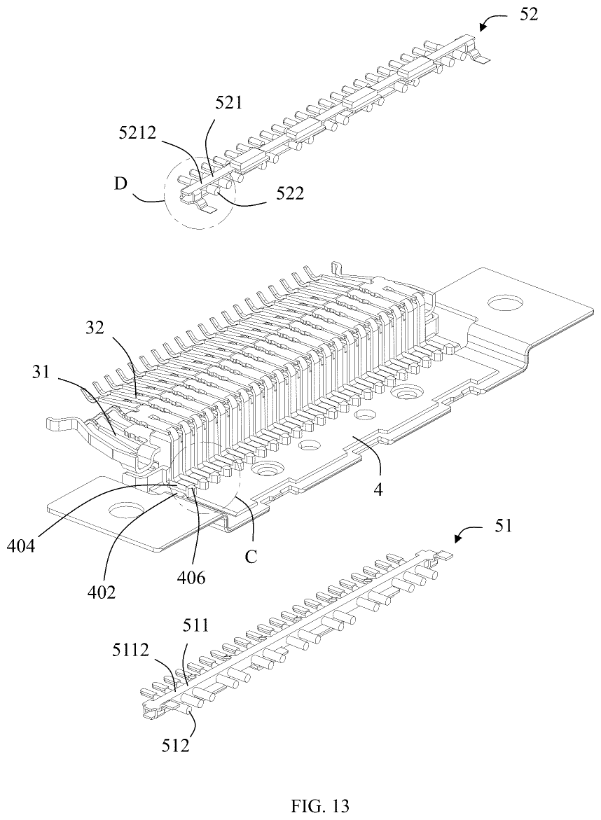

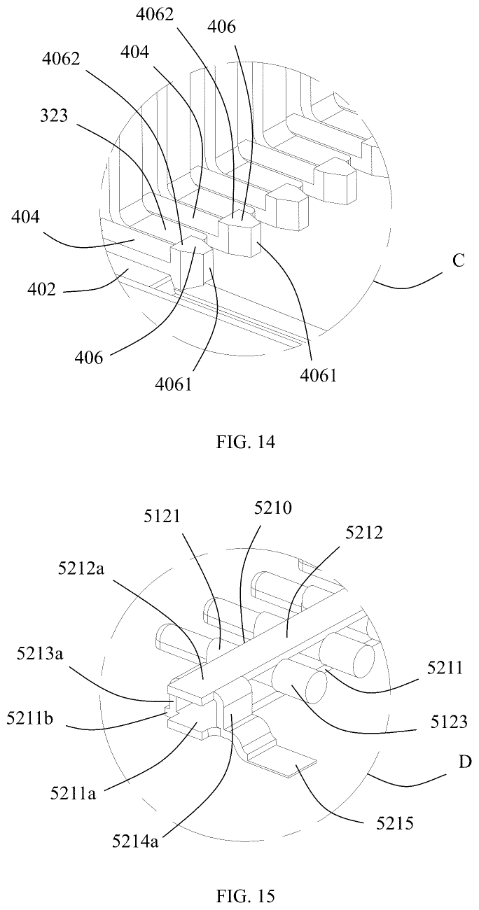

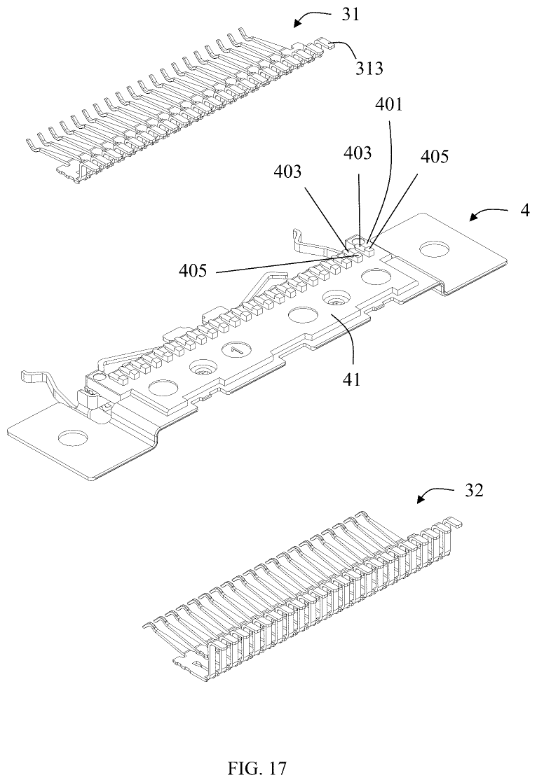

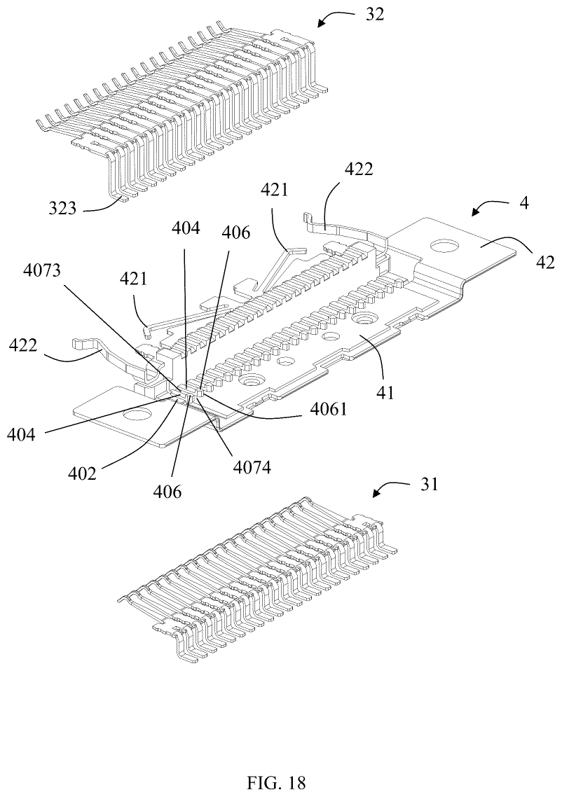

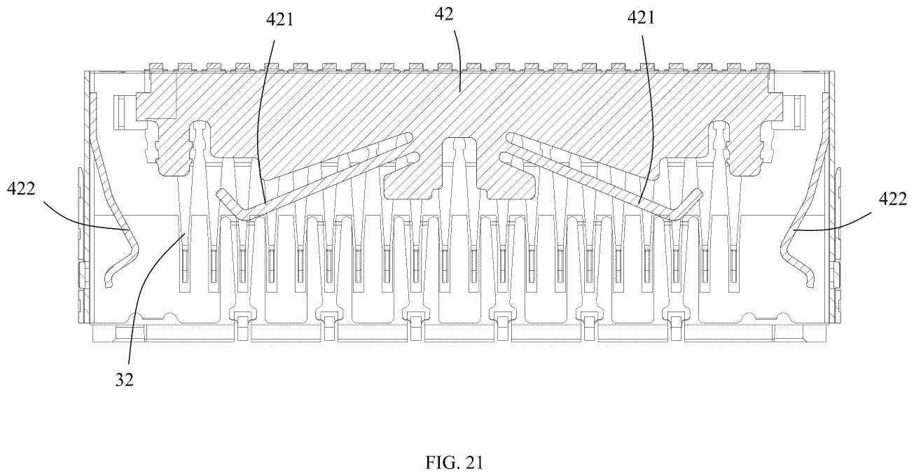

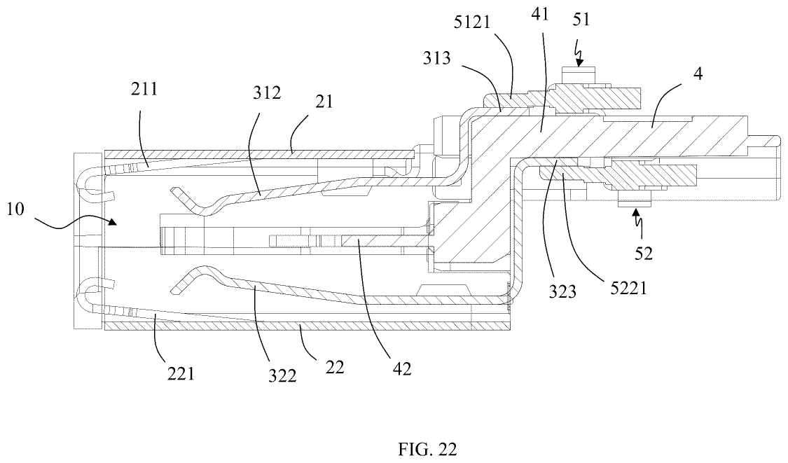

Referring to FIG. 1 to FIG. 22, the present disclosure discloses a cable connector 100, which includes an insulating body 1, a metal outer shell 2 coupled to the insulating body 1, a plurality of first conductive terminals 31 mounted to the insulating body 1, a plurality of second conductive terminals 32 mounted to the insulating body 1, a shielding piece assembly 4 mounted to the insulating body 1, a first cable module 51 electrically connected to the first conductive terminals 31, and a second cable module 52 electrically connected to the second conductive terminals 32.

In one embodiment of the present disclosure, the cable connector 100 is a cable connector used to cooperate with a charging port of an electronic device (for example, a laptop computer). Of course, it is understandable to those of ordinary skill in the art that the cable connector 100 can also be used for other purposes of transmitting data and/or power, which will not be described in detail in the present disclosure.

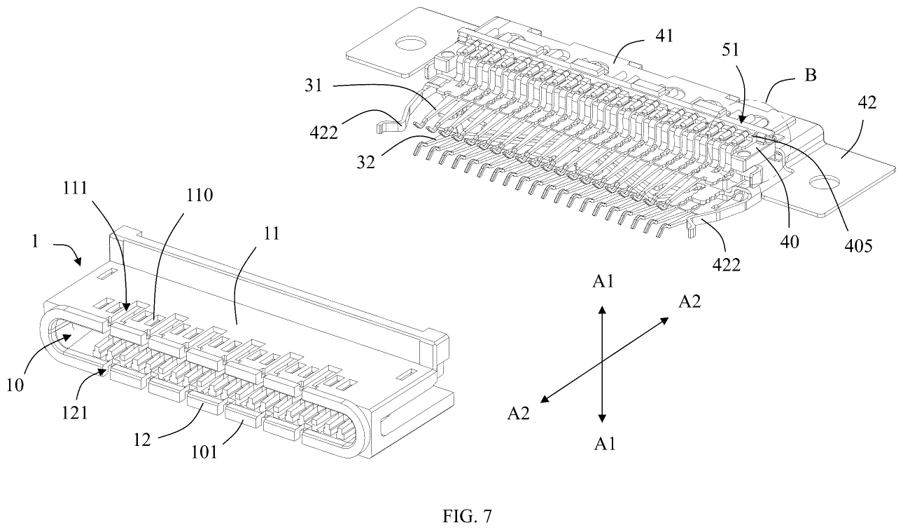

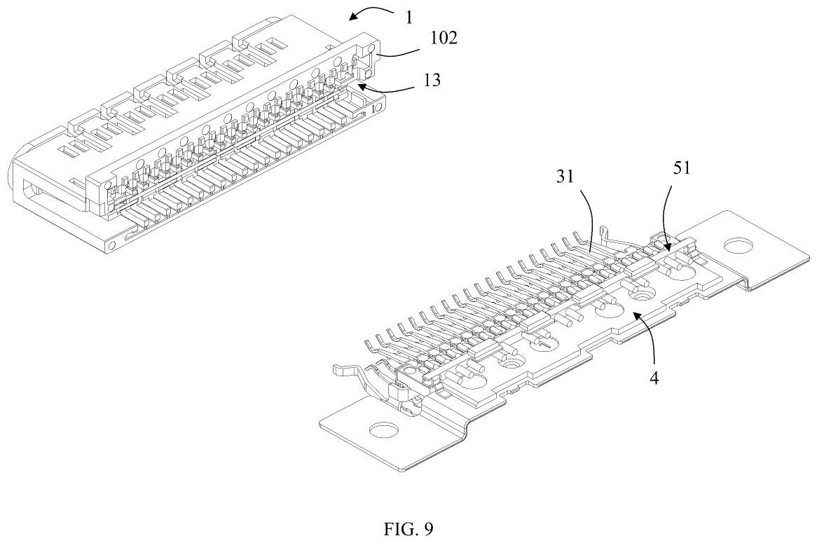

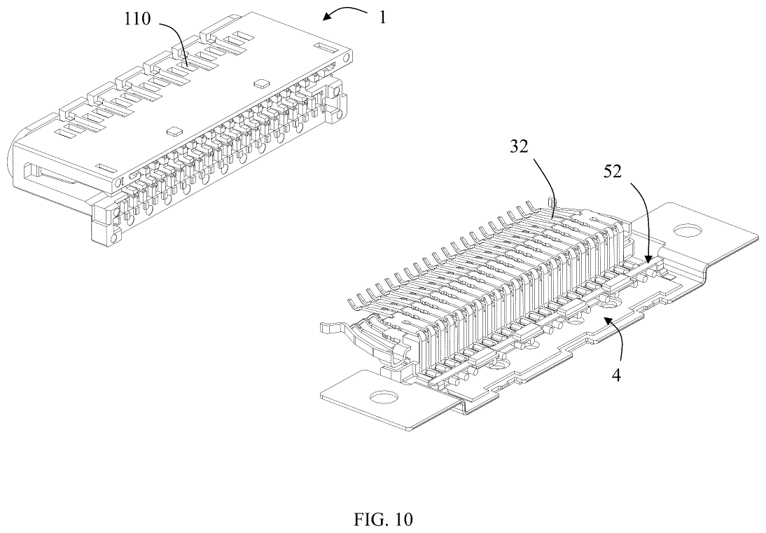

As shown in FIG. 7, FIG. 9 and FIG. 10, the insulating body 1 includes a first wall portion 11 (for example, a top wall), a second wall portion 12 (for example, a bottom wall) disposed opposite to the first wall portion 11, a mating cavity 10 located between the first wall portion 11 and the second wall portion 12, and an installation cavity 13 communicating with the mating cavity 10. The mating cavity 10 is configured to at least partially receive a mating connector (not shown). The installation cavity 13 is configured to install the shielding piece assembly 4.

In the illustrated embodiment of the present disclosure, the insulating body 1 further includes a mating surface 101 and an installation surface 102 disposed opposite to the mating surface 101. The mating cavity 10 extends forwardly through the mating surface 101. The installation cavity 13 extends backwardly through the installation surface 102.

Besides, the first wall portion 11 defines a plurality of first slots 111 extending through the first wall portion 11 along a first direction A1-A1 (for example, a vertical direction). The first slots 111 extend forwardly through the mating surface 101. Similarly, the second wall portion 12 defines a plurality of second slots 121 extending through the second wall portion 12 along the first direction A1-A1. The second slots 121 extend forwardly through the mating surface 101. Besides, the first wall portion 11 and the second wall portion 12 further define a plurality of heat dissipation slots 110 that penetrate the first wall portion 11 and the second wall portion 12, respectively, along the first direction A1-A1. The heat dissipation slots 110 are in communication with the mating cavity 10 for heat dissipation.

As shown in FIG. 1 to FIG. 6, the metal outer shell 2 includes a first metal outer shell 21 and a second metal outer shell 22. The insulating body 1 is circumferentially wrapped by the first metal outer shell 21 and the second metal outer shell 22. The first metal outer shell 21 and the second metal outer shell 22 are buckled together. The first metal outer shell 21 is provided with a plurality of first elastic abutment arms 211 protruding into the mating cavity 10 through the first slots 111. The second metal shell 22 is provided with a plurality of second elastic abutment arms 221 protruding into the mating cavity 10 through the second slots 121. In the illustrated embodiment of the present disclosure, each of the first elastic abutment arms 211 and the second elastic abutment arms 221 is provided with an abutting portion 212 that is bent backwardly and then bent forwardly. The abutting portion 212 protrudes into the mating cavity 10 to abut against the mating connector.

As shown in FIG. 7, in the illustrated embodiment of the present disclosure, the plurality of first conductive terminals 31 and the plurality of second conductive terminals 32 are arranged in upper and lower rows, respectively, and are mounted and fixed to the insulating body 1. Of course, it is understandable to those skilled in the art that the first conductive terminals 31 and the second conductive terminals 32 can also be fixed to the insulating body 1 in other ways (for example, insert molding), which will not be described in detail in the present disclosure.

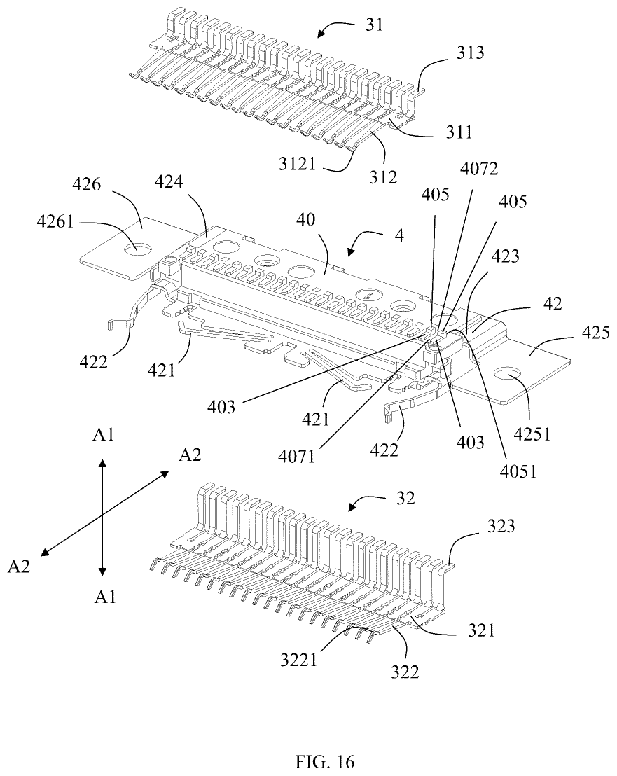

Referring to FIG. 16 to FIG. 18, in the illustrated embodiment of the present disclosure, each first conductive terminal 31 includes a first fixing portion 311 fixed in the insulating body 1, a first elastic arm 312 extending from one end (for example, a front end) of the first fixing portion 311, and a first tail portion 313 extending from another end (for example, a rear end) of the first fixing portion 311. The first elastic arm 312 is provided with a first contact portion 3121 protruding into the mating cavity 10. The first tail portion 313 is in a shape of a straight strip and extends backwardly along a horizontal direction.

Similarly, each second conductive terminal 32 includes a second fixing portion 321 fixed in the insulating body 1, a second elastic arm 322 extending from one end (for example, a front end) of the second fixing portion 321, and a second tail portion 323 extending from another end (for example, a rear end) of the second fixing portion 321. The second elastic arm 322 is provided with a second contact portion 3221 protruding into the mating cavity 10. The second tail portion 323 is in a shape of a straight strip and extends backwardly along the horizontal direction.

In the illustrated embodiment of the present disclosure, the first elastic arms 312 and the second elastic arms 322 are located on the upper and lower sides of the mating cavity 10, respectively. The first tail portions 313 and the second tail portions 323 are parallel to each other and located in the top and bottom directions, respectively.

In the illustrated embodiment of the present disclosure, the shielding piece assembly 4 includes an insulating fixing block 41 and a metal shielding piece 42 coupled to the insulating fixing block 41. In one embodiment of the present disclosure, the metal shielding piece 42 is insert-molded with the insulating fixing block 41. The insulating fixing block 41 is at least partially installed in the installation cavity 13.

The metal shielding piece 42 is provided with a plurality of first abutting elastic arms 421 protruding beyond the insulating fixing block 41 and located at a rear of the mating cavity 10, and a plurality of second abutting elastic arms 422 protruding beyond the insulating fixing block 41 and located at two sides of the mating cavity 10. The first abutting elastic arms 421 and the second abutting elastic arms 422 are configured to abut against the mating connector.

Besides, the metal shielding piece 42 further includes a first extension portion 423 exposed outside the insulating fixing block 41 and located on one side (for example, a left side) of the shielding piece assembly 4, a second extension portion 424 exposed outside the insulating fixing block 41 and located on another side (for example, a right side) of the shielding piece assembly 4, a first mounting portion 425 integrally extended from the first extension portion 423, and a second mounting portion 426 integrally extended from the second extension portion 424. The first mounting portion 425 defines a first mounting hole 4251. The second mounting portion 426 defines a second mounting hole 4261. The first mounting hole 4251 and the second mounting hole 4261 are used to cooperate with fasteners to fix the cable connector 100 to other components.

The insulating fixing block 41 includes a base portion 40. The base portion 40 includes a first surface 401 (for example, an upper surface), a second surface 402 disposed opposite to the first surface 401, a plurality of first ribs 403 extending upwardly beyond the first surface 401 along the first direction A1-A1, a plurality of second ribs 404 extending downwardly beyond the second surface 402 along the first direction A1-A1, a first positioning block 405 further extending upwardly beyond at least one of the first ribs 403 along the first direction A1-A1, and a second positioning block 406 further extending downwardly beyond at least one of the second ribs 404 along the first direction A1-A1.

In the illustrated embodiment of the present disclosure, a plurality of first positioning blocks 405 are provided and correspond to the first ribs 403 in a one-to-one correspondence manner. A plurality of second positioning blocks 406 are provided and correspond to the second ribs 404 in a one-to-one correspondence manner. Of course, it is understandable to those skilled in the art that the number of the first positioning blocks 405 and the second positioning blocks 406 can be flexibly adjusted as needed, which will not be described in detail in the present disclosure.

In the illustrated embodiment of the present disclosure, a first terminal tail portion mounting groove 4071 is formed between two adjacent first ribs 403. Each first positioning block 405 is provided with a first positioning surface 4051 located at a rear end of the first terminal tail portion mounting groove 4071 and a top surface 4052 protruding upwardly beyond the first rib 403. The first positioning surface 4051 is a vertical surface, and the first positioning surfaces 4051 of all the first positioning blocks 405 are located in a same plane.

In the illustrated embodiment of the present disclosure, a first cable positioning groove 4072 communicating with the first terminal tail portion mounting groove 4071 is formed between two adjacent first positioning blocks 405. The first tail portion 313 of the first conductive terminal 31 is at least partially received in a corresponding first terminal tail portion mounting groove 4071 to achieve a certain degree of positioning.

In the illustrated embodiment of the present disclosure, the first rib 403 extends integrally with the base portion 40. The first positioning block 405 extends integrally with a corresponding first rib 403. The first rib 403 and the first positioning block 405 are connected together to form a step-shaped configuration.

Similarly, in the illustrated embodiment of the present disclosure, a second terminal tail portion mounting groove 4073 is formed between two adjacent second ribs 404. Each second positioning block 406 is provided with a second positioning surface 4061 located at a rear end of the second terminal tail portion mounting groove 4073 and a bottom surface 4062 protruding upwardly beyond the second rib 404. The second positioning surface 4061 is a vertical surface, and the second positioning surfaces 4061 of all the second positioning blocks 406 are located in a same plane.

In the illustrated embodiment of the present disclosure, a second cable positioning groove 4074 communicating with the second terminal tail portion mounting groove 4073 is formed between two adjacent second positioning blocks 406. The second tail portion 323 of the second conductive terminal 32 is at least partially received in a corresponding second terminal tail portion mounting groove 4073 to achieve a certain degree of positioning.

In the illustrated embodiment of the present disclosure, the second rib 404 extends integrally with the base portion 40. The second positioning block 406 extends integrally with a corresponding second rib 404. The second rib 404 and the second positioning block 406 are connected together to form a step-shaped configuration.

It is understandable to those skilled in the art that in other embodiments of the present disclosure, the base portion 40 can also be formed on the insulating body 1.

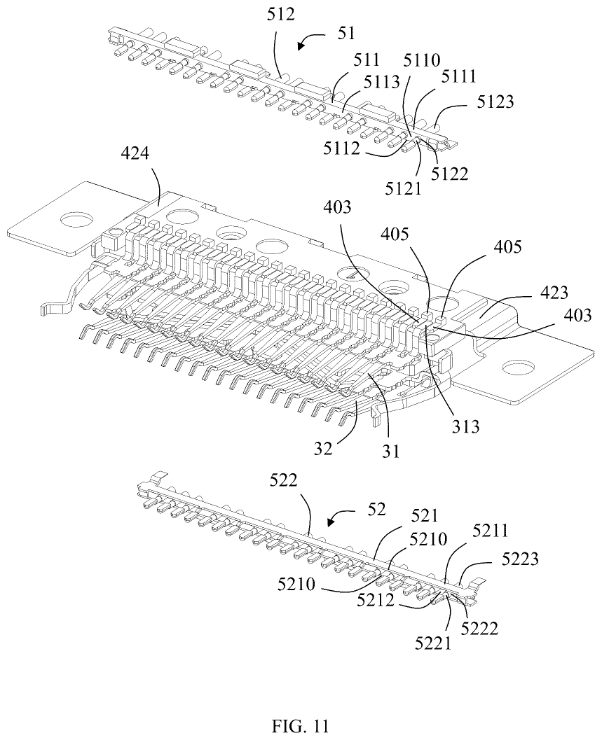

As shown in FIG. 11 to FIG. 13, the first cable module 51 includes a first metal bar 511 and a plurality of first cables 512. In the illustrated embodiment of the present disclosure, the plurality of first cables 512 partially pass through the first metal bar 511 to be fixed to the first metal bar 511. Of course, in other embodiments of the present disclosure, the first cables 512 can also be fixed to the first metal bar 511 in other ways.

The first cable 512 includes a first core wire 5121, a first insulation layer 5122 wrapped on the first core wire 5121 and a first insulation skin 5123 disposed outside the first insulation layer 5122. The first core wire 5121 of the first cable 512 is configured to be electrically connected (for example, soldered or welded) to a corresponding first tail portion 313 of the first conductive terminal 31.

In some embodiments of the present disclosure, the first cable 512 may further be provided with a first shielding layer located between the first insulation layer 5122 and the first insulation skin 5123. At this time, the first shielding layers of all the first cables 512 can be connected as a whole by contacting the first shielding layers with the first metal bar 511, thereby improving the shielding effect.

In the illustrated embodiment of the present disclosure, the first metal bar 511 is provided with a first abutting surface 5110. The first core wire 5121 protrudes forward beyond the first abutting surface 5110. The first cable module 51 is mounted to the base portion 40. The first metal bar 511 is supported on the first surface 401 of the base portion 40. The first abutting surface 5110 of the first metal bar 511 abuts against the first positioning surface 4051 of the first positioning block 405 along a second direction A2-A2 (for example, a front-rear direction), so as to limit the first cable module 51 in the second direction A2-A2. The second direction A2-A2 is perpendicular to the first direction A1-A2. The first metal bar 511 is in contact with the metal shielding piece 42.

In the illustrated embodiment of the present disclosure, the first abutting surfaces 5110 are all vertical surfaces. By the first abutting surface 5110 abutting against the first positioning surface 4051, when the first cable module 51 is installed from back to front along the second direction A2-A2, the first positioning surface 4051 is able to position the first cable module 51, thereby avoiding the problem that the first cable module 51 is not installed in place in the second direction A2-A2. In addition, by supporting the first metal bar 511 on the first surface 401 of the base portion 40, the first cable module 51 can also be positioned along the first direction A1-A1.

After the first cable module 51 is installed in place, the first cables 512 are at least partially received in the first cable positioning grooves 4072. In the illustrated embodiment of the present disclosure, the first core wire 5121 of the first cable 512 is configured to be fixed to the corresponding first tail portion 313 of the first conductive terminal 31 by soldering or welding. In the illustrated embodiment of the present disclosure, a height of the first positioning block 405 protruding upwardly beyond the first rib 403 needs to be set reasonably to ensure that: on the one hand, the height of the first positioning block 405 protruding upwardly beyond the first rib 403 can reliably block the first abutting surface 5110 of the first metal bar 511; and on the other hand, it prevents the first positioning block 405 protruding upwardly beyond the first rib 403 to a height that is too high and affects the soldering or welding of the first core wire 5121 of the first cable 512 and the first tail portion 313 of the first conductive terminal 31. When the height of the first positioning block 405 protruding upwardly beyond the first rib 403 is too high, the soldering or welding gun may easily touch the first positioning block 405, causing it to melt, thereby affecting the appearance and easily causing failure.

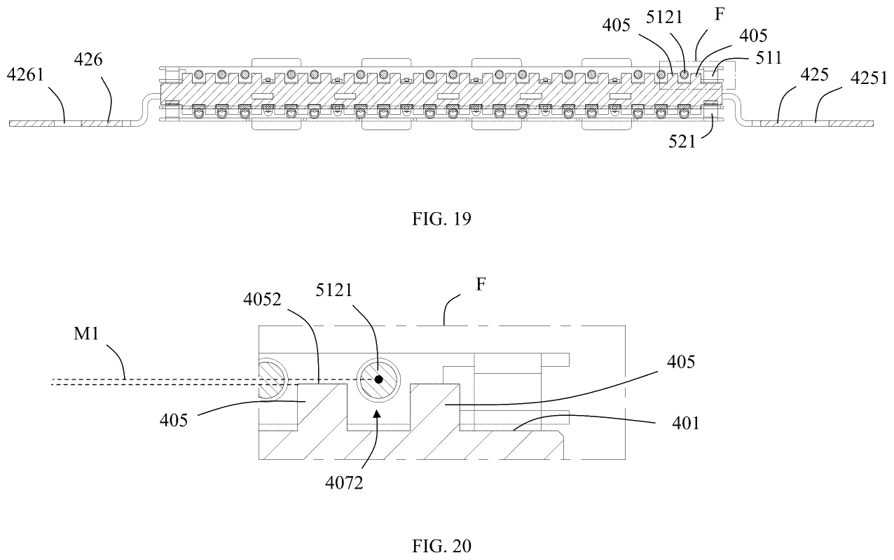

Referring to FIG. 19 and FIG. 20, in the illustrated embodiment of the present disclosure, a center of the first core wire 5121 of the first cable 512 is located in a first horizontal plane M1. The top surface 4052 of the first positioning block 405 is not higher than the first horizontal plane M1. Preferably, the top surface 4052 of the first positioning block 405 is slightly lower than the first horizontal plane M1.

In the illustrated embodiment of the present disclosure, the first positioning surfaces 4051 of all the first positioning blocks 405 are located in a same plane to jointly abut against the first abutting surface 5110 of the first metal bar 511, thereby improving the structural strength.

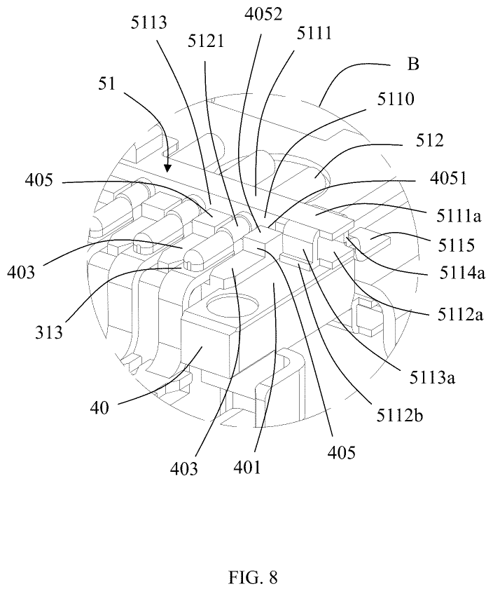

Referring to FIG. 8 and FIG. 11 to FIG. 13, in the illustrated embodiment of the present disclosure, the first metal bar 511 includes a first top wall 5111, a first bottom wall 5112 disposed opposite to the first top wall 5111, a first front end wall 5113 connecting the first top wall 5111 and the first bottom wall 5112, and a first rear end wall 5114 connecting the first top wall 5111 and the first bottom wall 5112. In the illustrated embodiment of the present disclosure, the first abutting surface 5110 is provided on the first front end wall 5113. The first bottom wall 5112 is supported on the first surface 401 of the base portion 40.

More specifically, in the illustrated embodiment of the present disclosure, the first top wall 5111 includes a first extension top portion 5111a located at a side end. The first bottom wall 5112 includes a first extension bottom portion 5112a located at a side end. The first metal bar 511 includes a first front end connection portion 5113a connecting a front end of the first extension top portion 5111 and a front end of the first extension bottom portion 5112a. The first metal bar 511 further includes a first rear end connection portion 5114a connecting a rear end of the first extension top portion 5111 and a rear end of the first extension bottom portion 5112a. The first extension top portion 5111a, the first front end connection portion 5113a, the first extension bottom portion 5112a and the first rear end connection portion 5114a are enclosed in a frame shape to increase structural strength. The first extension bottom portion 5112a is supported on the first surface 401 of the base portion 40.

In addition, the first bottom wall 5112 includes a first protruding portion 5112b extending forwardly from the first extension bottom portion 5112a. The first protruding portion 5112b protrudes forwardly beyond the first front end connection portion 5113a. The first protruding portion 5112b is supported on the first surface 401 of the base portion 40. The first metal bar 511 further includes a first extension tail portion 5115 extending backwardly beyond the first rear end connection portion 5114a. The first extension tail portion 5115 is configured to be in contact with the first extension portion 423 of the metal shielding piece 42. Preferably, the first extension tail portion 5115 and the first extension portion 423 of the metal shielding piece 42 are fixed by soldering or welding.

In an embodiment of the present disclosure, the left and right sides of the first metal bar 511 are arranged symmetrically. As to the structures on the other side of the first metal bar 511, reference can be made to the one side described above, which will not be described again in the present disclosure.

The second cable module 52 includes a second metal bar 521 and a plurality of second cables 522. In the illustrated embodiment of the present disclosure, the plurality of second cables 522 partially pass through the second metal bar 521 to be fixed to the second metal bar 521. Of course, in other embodiments of the present disclosure, the second cables 522 can also be fixed to the second metal bar 521 in other ways.

The second cable 522 is provided with a second core wire 5221, a second insulation layer 5222 wrapped on the second core wire 5221, and a second insulation skin 5223 located outside the second insulation layer 5222. The second core wire 5221 of the second cable 522 is configured to be electrically connected (for example, soldered or welded) to a corresponding second tail portion 323 of the second conductive terminal 32.

In some embodiments of the present disclosure, the second cable 522 may further be provided with a second shielding layer located between the second insulation layer 5222 and the second insulation skin 5223. At this time, the second shielding layers of all the second cables 522 can be connected as a whole by contacting the second shielding layers with the second metal bar 521, thereby improving the shielding effect.

In the illustrated embodiment of the present disclosure, the second metal bar 521 is provided with a second abutting surface 5210. The second core wire 5221 protrudes forwardly beyond the second abutting surface 5210. The second cable module 52 is mounted to the base portion 40. The second metal bar 521 is supported on the second surface 402 of the base portion 40. The second abutting surface 5210 of the second metal bar 521 abuts against the second positioning surface 4061 of the second positioning block 406 along the second direction A2-A2 (for example, the front-rear direction), so as to limit the second cable module 52 in the second direction A2-A2. The second metal bar 521 is in contact with the metal shielding piece 42.

In the illustrated embodiment of the present disclosure, the second contact surfaces 5210 are all vertical surfaces. The second contact surfaces 5210 abut against the second positioning surface 4061. When the second cable module 52 is installed from back to front along the second direction A2-A2, the second positioning surface 4061 is able to position the second cable module 52, which avoids the problem that the second cable module 52 is not installed properly in the second direction A2-A2. In addition, by supporting the second metal bar 521 on the second surface 402 of the base portion 40, the second cable module 52 can also be positioned along the first direction A1-A1.

After the second cable module 52 is installed in place, the second cables 522 are at least partially received in the second cable positioning grooves 4074. In the illustrated embodiment of the present disclosure, the second core wire 5221 of the second cable 522 is configured to be fixed to the corresponding second tail portion 323 of the second conductive terminal 32 by soldering or welding. In the illustrated embodiment of the present disclosure, a height of the second positioning block 406 protruding downwardly beyond the second rib 404 needs to be set reasonably to ensure that: on the one hand, the height of the second positioning block 406 protruding downwardly beyond the second rib 404 can reliably block the second abutting surface 5210 of the second metal bar 521; and on the other hand, it prevents the second positioning block 406 protruding downwardly beyond the second rib 404 to a height that is too high and affects the soldering or welding of the second core wire 5221 of the second cable 522 and the second tail portion 323 of the second conductive terminal 32. When the height of the second positioning block 406 protruding downwardly beyond the second rib 404 is too high, the soldering or welding gun may easily touch the second positioning block 406, causing it to melt, thereby affecting the appearance and easily causing failure.

In the illustrated embodiment of the present disclosure, the second positioning surfaces 4061 of all the second positioning blocks 406 are located in a same plane to jointly abut against the second abutting surface 5210 of the second metal bar 521, thereby improving the structural strength.

In the illustrated embodiment of the present disclosure, the second metal bar 521 includes a second top wall 5211 and a second bottom wall 5212 disposed opposite to the second top wall 5211. In the illustrated embodiment of the present disclosure, the second abutting surface 5210 is provided on the second top wall 5211. The second bottom wall 5212 is supported on the second surface 402 of the base portion 40.

More specifically, in the illustrated embodiment of the present disclosure, the second top wall 5211 includes a second extension top portion 5211a located at a side end. The second bottom wall 5212 includes a second extension bottom portion 5212a located at a side end. The second metal bar 521 includes a second front end connection portion 5213a connecting a front end of the first extension top portion 5111 and a front end of the second extension bottom portion 5212a. The second metal bar 521 further includes a second rear end connection portion 5214a connecting a rear end of the first extension top portion 5111 and a rear end of the second extension bottom portion 5212a. The second extension top portion 5211a, the second front end connection portion 5213a, the second extension bottom portion 5212a and the second rear end connection portion 5214a are enclosed in a frame shape to increase structural strength. The second extension top portion 5211a is supported on the second surface 402 of the base portion 40.

Besides, the second top wall 5211 includes a second protruding portion 5211b extending forwardly from the second extension top portion 5211a. The second protruding portion 5211b protrudes forwardly beyond the second front end connection portion 5213a. The second protruding portion 5211b is supported on the second surface 402 of the base portion 40. The second metal bar 521 further includes a second extension tail portion 5215 extending backwardly beyond the second rear end connection portion 5214a. The second extension tail portion 5215 is configured to be in contact with the first extension portion 423 of the metal shielding piece 42. Preferably, the second extension tail portion 5215 and the first extension portion 423 of the metal shielding piece 42 are fixed by soldering or welding.

In one embodiment of the present disclosure, the left and right sides of the second metal bar 521 are arranged symmetrically. As to the structures on the other side of the second metal bar 521, reference can be made to the one side described above, which will not be described again in the present disclosure.

The cable connector 100 of the present disclosure is provided with the base portion 40. The base portion 40 includes the first positioning block 405. The first positioning block 405 is provided with the first positioning surface 4051 located at the rear end of the first terminal tail portion mounting groove 4071. The first cable module 51 is mounted to the base portion 40. The first metal bar 511 is supported on the first surface 401 of the base portion 40 to position the first cable module 51 in the first direction A1-A1. The first abutting surface 5110 of the first metal bar 511 abuts against the first positioning surface 4051 of the first positioning block 405 along the second direction A2-A2, so as to limit the first cable module 51 in the second direction A2-A2, thereby improving the yield of the manufacturing process.

The positioning achieved when the second cable module 52 is mounted to the base portion 40 is similar to that of the first cable module 51, which will not be described again in the disclosure.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A cable connector, comprising:
a base portion, the base portion comprising a first surface, a plurality of first ribs extending beyond the first surface along a first direction, and a first positioning block further extending beyond at least one of the plurality of first ribs along the first direction; a first terminal tail portion mounting groove being formed between two adjacent first ribs; the first positioning block being provided with a first positioning surface located at an end of the first terminal tail portion mounting groove along a second direction perpendicular to the first direction;
a metal shielding piece, the metal shielding piece being coupled to the base portion;
a plurality of first conductive terminals, each first conductive terminal comprising a first tail portion which is at least partially received in a corresponding first terminal tail portion mounting groove; and
a first cable module, the first cable module comprising a first metal bar and a plurality of first cables; the first metal bar comprising a first abutting surface; each first cable comprising a first core wire protruding beyond the first abutting surface;
wherein the first cable module is mounted to the base portion; the first metal bar is supported on the first surface of the base portion; the first abutting surface of the first metal bar abuts against the first positioning surface of the first positioning block along the second direction, so as to limit the first cable module in the second direction; the first core wire of the first cable is configured to be electrically connected to a corresponding first tail portion of the first conductive terminal; the first metal bar is in contact with the metal shielding piece.

2. The cable connector according to claim 1, wherein the first positioning surface and the first abutting surface are both vertical surfaces.

3. The cable connector according to claim 1, wherein the first rib extends integrally with the base portion; the first positioning block extends integrally with a corresponding first rib.

4. The cable connector according to claim 1, wherein a plurality of first positioning blocks are provided and correspond to the first ribs in a one-to-one correspondence manner; a first cable positioning groove communicating with the first terminal tail portion mounting groove is formed between two adjacent first positioning blocks; the first cable is at least partially received in the first cable positioning groove.

5. The cable connector according to claim 4, wherein the first positioning surfaces of all the first positioning blocks are located in a same plane to jointly abut against the first abutting surface of the first metal bar.

6. The cable connector according to claim 1, wherein the plurality of first cables partially pass through the first metal bar and are fixed to the first metal bar.

7. The cable connector according to claim 1, wherein the first metal bar comprises a first top wall, a first bottom wall disposed opposite to the first top wall, and a first front end wall connecting the first top wall and the first bottom wall; the first abutting surface is provided on the first front end wall; the first bottom wall is supported on the first surface of the base portion.

8. The cable connector according to claim 7, wherein the first top wall comprises a first extension top portion located at a side end; the first bottom wall comprises a first extension bottom portion located at a side end; the first metal bar comprises a first front end connection portion connecting a front end of the first extension top portion and a front end of the first extension bottom portion; the first metal bar further comprises a first rear end connection portion connecting a rear end of the first extension top portion and a rear end of the first extension bottom portion; the first extension top portion, the first front end connection portion, the first extension bottom portion and the first rear end connection portion form a frame-shaped configuration;
the first extension bottom portion is supported on the first surface of the base portion.

9. The cable connector according to claim 8, wherein the first bottom wall comprises a first protruding portion extending forwardly from the first extension bottom portion; the first protruding portion protrudes forwardly beyond the first front end connection portion; the first protruding portion is supported on the first surface of the base portion.

10. The cable connector according to claim 8, wherein the first metal bar comprises a first extension tail portion extending backwardly beyond the first rear end connection portion; the first extension tail portion is configured to be in contact with the metal shielding piece.

11. The cable connector according to claim 10, wherein the metal shielding piece comprises a first extension portion exposed outside the base portion and a first mounting portion integrally extended from the first extension portion; the first mounting portion defines a first mounting hole; the first extension tail portion and the first extension portion are fixed by soldering or welding.

12. The cable connector according to claim 1, further comprising an insulating body which defines a mating cavity;
wherein the plurality of first conductive terminals are mounted to the insulating body; each first conductive terminal comprises a first fixing portion fixed to the insulating body and a first elastic arm extending from one end of the first fixing portion; the first elastic arm is provided with a first contact portion protruding into the mating cavity; the first tail portion extends from another end of the first fixing portion.

13. The cable connector according to claim 12, wherein the insulating body defines an installation cavity communicating with the mating cavity;
the cable connector comprises an insulating fixing block on which the base portion is provided; the insulating fixing block is at least partially installed in the installation cavity;
the metal shielding piece is insert-molded with the insulating fixing block; the metal shielding piece is provided with a first abutting elastic arm protruding beyond the insulating fixing block and located at a rear of the mating cavity, and a plurality of second abutting elastic arms protruding beyond the insulating fixing block and located at two sides of the mating cavity.

14. The cable connector according to claim 12, further comprising a first metal outer shell and a second metal outer shell; the insulating body being circumferentially wrapped by the first metal outer shell and the second metal outer shell; the first metal outer shell and the second metal outer shell being fixed together; the first metal outer shell and/or the second metal outer shell being in contact with the metal shielding piece;
wherein the insulating body is provided with a first wall portion and a second wall portion disposed opposite to the first wall portion; the mating cavity is located between the first wall portion and the second wall portion; the first wall portion defines at least one first slot extending through the first wall portion along the first direction; the second wall portion defines at least one second slot extending through the second wall portion along the first direction;
the first metal outer shell is provided with a first elastic abutment arm protruding into the mating cavity through the first slot; the second metal outer shell is provided with a second elastic abutment arm protruding into the mating cavity through the second slot.

15. The cable connector according to claim 1, wherein the base portion is provided with a second surface disposed opposite to the first surface, a plurality of second ribs extending downwardly beyond the second surface, and a second positioning block further extending downwardly beyond at least one of the plurality of second ribs; a second terminal tail portion mounting groove is formed between two adjacent second ribs; the second positioning block is provided with a second positioning surface located at an end of the second terminal tail portion mounting groove along the second direction;
the cable connector further comprises:
a plurality of second conductive terminals, each second conductive terminal comprises a second tail portion which is at least partially received in a corresponding second terminal tail portion mounting groove; and
a second cable module, the second cable module comprises a second metal bar and a plurality of second cables; the second metal bar is provided with a second abutting surface; each second cable comprises a second core wire extending beyond the second abutting surface;
the second cable module is mounted to the base portion; the second metal bar is supported on the second surface of the base portion; the second abutting surface of the second metal bar abuts against the second positioning surface of the second positioning block along the second direction, so as to limit the second cable module in the second direction; the second core wire of the second cable is configured to be electrically connected to a corresponding second tail portion of the second conductive terminal; the second metal bar is in contact with the metal shielding piece.

16. The cable connector according to claim 15, wherein the second rib extends integrally with the base portion; the second positioning block extends integrally with a corresponding second rib;
a plurality of second positioning blocks are provided and correspond to the second ribs in a one-to-one correspondence manner; a second cable positioning groove communicating with the second terminal tail portion mounting groove is formed between two adjacent second positioning blocks; the second cable is at least partially received in the second cable positioning groove;
the second positioning surfaces of all the second positioning blocks are located in a same plane to jointly abut against the second abutting surface of the second metal bar.

17. The cable connector according to claim 1, wherein a center of the first core wire of the first cable is located in a first horizontal plane; the first positioning block is provided with a top surface which is no higher than the first horizontal plane.

18. A cable connector, comprising:
an insulating body defining a mating cavity;
a base portion mounted to the insulating body, the base portion comprising a first surface, a plurality of first ribs integrally extending beyond the first surface along a first direction, and a first positioning block further integrally extending beyond at least one of the plurality of first ribs along the first direction; a first terminal tail portion mounting groove being formed between two adjacent first ribs; the first positioning block being provided with a first positioning surface;
a metal shielding piece mounted to the base portion, the metal shielding piece comprising at least one abutting elastic arm extending into the mating cavity;
a plurality of first conductive terminals, each first conductive terminal comprising a first tail portion which is at least partially received in a corresponding first terminal tail portion mounting groove; and
a first cable module, the first cable module comprising a first metal bar and a plurality of first cables fixed together with the first metal bar; the first metal bar comprising a first abutting surface; each first cable comprising a first core wire protruding beyond the first abutting surface;
wherein the first cable module is mounted to the base portion; the first metal bar is supported on the base portion; the first abutting surface of the first metal bar abuts against the first positioning surface of the first positioning block along a second direction, so as to limit the first cable module in the second direction; the second direction is perpendicular to the first direction; the first core wire of the first cable is configured to be electrically connected to a corresponding first tail portion of the first conductive terminal; the first metal bar is in contact with the metal shielding piece.

19. The cable connector according to claim 18, wherein the first metal bar comprises a first top wall, a first bottom wall disposed opposite to the first top wall, and a first front end wall connecting the first top wall and the first bottom wall; the first abutting surface is provided on the first front end wall; the first bottom wall is supported on the first surface of the base portion.

20. The cable connector according to claim 19, wherein the first top wall comprises a first extension top portion located at a side end; the first bottom wall comprises a first extension bottom portion located at a side end; the first metal bar comprises a first front end connection portion connecting a front end of the first extension top portion and a front end of the first extension bottom portion; the first metal bar further comprises a first rear end connection portion connecting a rear end of the first extension top portion and a rear end of the first extension bottom portion; the first extension top portion, the first front end connection portion, the first extension bottom portion and the first rear end connection portion form a frame-shaped configuration;
the first extension bottom portion is supported on the first surface of the base portion.
